(19) United States
(12) Patent Application Publication
(10) Pub. No.: US 2026/0276489 A1
(43) Pub. Date: Sep. 17, 2026

(54) COMPOSITIONS, KITS, AND METHODS FOR SILVER STAINING

(71) Applicant: VENTANA MEDICAL SYSTEMS, INC., Tucson, AZ (US)

(72) Inventors: Edward E. Durrant, Tucson, AZ (US); Eric L. Klein, Tucson, AZ (US); Jian Zhang, Tucson, AZ (US)

(21) Appl. No.: 19/669,714

(22) Filed: May 6, 2026

Related U.S. Application Data
(63) Continuation of application No. PCT/US2025/047778, filed on Sep. 24, 2025.
(60) Provisional application No. 63/700,310, filed on Sep. 27, 2024.

(51) Int. Cl. G01N 1/30; G01N 1/31

(52) U.S. Cl. CPC G01N 1/30; G01N 1/31

(57) ABSTRACT

The present disclosure provides for a silver buffer composition for the staining of biological samples, where the disclosed silver buffer compositions are free from borax. In some embodiments, the silver buffer compositions include water, isopropyl alcohol, triethanolamine, and DABCO, wherein the composition has a pH ranging from about 9.3 to about 9.9. Also disclosed are methods of staining a biological sample using the disclosed silver buffer compositions.

### CROSS REFERENCE TO RELATED APPLICATIONS

The present application is a continuation of International Patent Application No. PCT/US2025/047778, filed on Sep. 24, 2025, which application claims the benefit of the filing date of U.S. Provisional Application No. 63/700,310 filed on Sep. 27, 2024, the disclosure of which is hereby incorporated by reference herein in its entirety.

### FIELD OF THE INVENTION

The present disclosure relates to compositions for staining biological samples, such as staining biological samples to visualize a basement membrane.

### BACKGROUND OF THE DISCLOSURE

Silver staining is intended for use in the histological demonstration of the basement membrane and reticular fibers. Silver staining is particularly important in biopsy interpretation in nephropathology with regard to visualizing the basal lamina and its associated changes. For instance, a thickened glomerular basement membrane, a type of connective tissue upon which epithelial cells rest, is often a sign of kidney disease and diabetes. These membranes are difficult to distinguish with hematoxylin and eosin staining alone.

Silver staining of histological section is performed using a “Jones silver” stain or “Jones methenamine silver” stain (hereinafter referred to as “Jones Stains”). The Jones Stain can highlight extracellular matrix proteins, adhesions to the Bowman's capsule, and breaks within the capillary basement membrane; providing contrast and resolution of these delicate structures.

The staining reaction is based on aldehyde reduction of silver ions to metallic silver under alkaline conditions. Periodic acid is used to oxidize carbohydrates to aldehyde groups. Components of the Jones Stain (such as those components available from Ventana Medical Systems, Inc.; Tucson, AZ) include silver nitrate, sodium borate, and methenamine, which form a methenamine-silver complex that is easily reduced to metallic silver by the aldehyde groups. To enhance staining contrast, toning of a tissue specimen is completed using gold chloride. Introduction of thiosulfate stops the reaction and removes any unreduced silver from the section. Nuclei are stained with hematoxylin (e.g., Jones Hematoxylin, available from Ventana Medical Systems, Inc., Tucson, AZ); and may also be further stained with eosin and/or a light green stain (e.g., Jones Eosin and Jones Light Green, both available from Ventana Medical Systems, Inc.; Tucson, AZ) or other counterstains.

It is believed that at least one component of the Jones Stain is not REACH-compliant, namely borax. REACH (Registration, Evaluation, Authorization and Restriction of Chemicals) is a regulation of the European Union, adopted to improve the protection of human health and the environment from the risks that can be posed by chemicals, while enhancing the competitiveness of the European Union chemicals industry. REACH shifts the responsibility from public authorities to industry with regard to assessing and managing the risks posed by chemicals and providing appropriate safety information for their users.

It has also been found that, upon aging, Jones Staining kits tend to produce relatively dark staining intensity and/or increased non-specific staining as compared with fresh kits. It is believed that this altered staining is caused by the chemical degradation of methenamine over time, which results in the formation of formaldehyde. It is further believed that the formed formaldehyde causes staining variability and non-specific staining since it can directly reduce silver ion to silver metal in solution.

### BRIEF SUMMARY OF THE DISCLOSURE

In view of the foregoing, Applicant has developed a silver buffer composition for the silver staining of biological samples, where the disclosed silver buffer composition is free of borax, and is hence REACH compliant, while also being free of methenamine and the inherent variability associated with it. Removal of borax from Jones Staining kits required identifying REACH-compliant ingredients that would be capable of mimicking the behavior of borax/methenamine with regard to the stability and reduction potential of silver ion, while not negatively impacting expected and appropriate tissue staining relative to that of the current on-market products. In addition to being REACH-compliant, Applicant has unexpectedly discovered that the disclosed silver buffer compositions are not susceptible to staining variability over the useful life the composition.

A first aspect of the present disclosure is a composition comprising: (a) a solvent; (b) a silver complexing agent, such as wherein the silver complexing agent is other than methenamine; (c) a pH buffering compound, such as wherein the pH buffering compound is not borax; and (d) a pH adjuster. In some embodiments, the solvent comprises water and a lower alcohol. In some embodiments, the lower alcohol is a C₁-C₄ alcohol. In some embodiments, the C₁-C₄ alcohol is isopropyl alcohol.

In some embodiments, the pH buffering compound has a pKa of greater than about 8.5. In some embodiments, the pH buffering compound has a pKa of greater than about 9. In some embodiments, the pH buffering compound is selected from 2,4-pentanedionate, a carbonate (H₂CO₃) salt (such as sodium carbonate), 1,4-diazabicyclo[2.2.2]octane (DABCO), a pyrophosphate (e.g., disodium pyrophosphate (Na₂H₂P₂O₇), tetrasodium pyrophosphate (Na₄P₂O₇)), 3-(N-morpholino) propanesulfonic acid (MOPS), 3-(Cyclohexylamino)-2-hydroxy-1-propanesulfonic acid (CAPSO), N-(1,1-Dimethyl-2-hydroxyethyl)-3-amino-2-hydroxypropanesulfonic acid (AMPSO), trimethylamine, sodium 2,4-pentanedionate, and N-cyclohexyl-2-aminoethanesulfonic acid (CHES). In some embodiments, the pH buffering compound is 1,4-diazabicyclo[2.2.2]octane.

In some embodiments, the silver complexing agent has a pKa of less than about 8.5. In some embodiments, the silver complexing agent has a pKa of less than about 9. In some embodiments, the silver complexing agent is selected from ethanolamine (2-aminoethanol), triethanolamine (N(CH₂CH₂OH)₃), 1,3-bis(tris(hydroxymethyl)methylamino) propane (referred to as “BIS-TRIS Propane” or “BTP”), and 4-(2-hydroxyethyl) morpholine (HEMO). In some embodiments, the silver complexing agent is triethanolamine.

In some embodiments, the composition has a pH ranging from between about 9.5 to about 9.7. In some embodiments, the pH adjuster is a strong acid. In some embodiments, the strong acid is selected from hydrochloric acid, sulfuric acid, perchloric acid, nitric acid, and mixtures thereof. In some embodiments, the pH adjuster is a weak acid.

A second aspect of the present disclosure is a composition comprising water, isopropyl alcohol, triethanolamine, and DABCO, wherein the composition has a pH ranging from about 9.3 to about 9.9. In some embodiments, the isopropyl alcohol is present in an amount of about 15% v/v %. In some embodiments, the triethanolamine is present in an amount ranging from between about 230 mM to about 270 mM. In some embodiments, the DABCO is present in an amount ranging from between about 120 mM to about 150 mM. In some embodiments, the composition further includes a reducing sugar.

A third aspect of the present disclosure is a composition consisting essentially of water, isopropyl alcohol, triethanolamine, and DABCO, wherein the composition has a pH ranging from about 9.3 to about 9.9. In some embodiments, the isopropyl alcohol is present in an amount of about 15% v/v %. In some embodiments, the triethanolamine is present in an amount ranging from between about 230 mM to about 270 mM. In some embodiments, the DABCO is present in an amount ranging from between about 120 mM to about 150 mM.

A fourth aspect of the present disclosure is a composition consisting of water, isopropyl alcohol, triethanolamine, and DABCO, wherein the composition has a pH ranging from about 9.3 to about 9.9. In some embodiments, the isopropyl alcohol is present in an amount of about 15% v/v %. In some embodiments, the triethanolamine is present in an amount ranging from between about 230 mM to about 270 mM. In some embodiments, the DABCO is present in an amount ranging from between about 120 mM to about 150 mM.

A fifth aspect of the present disclosure is a method of staining a biological sample, comprising: (i) dispensing a silver-staining composition comprising silver ions to the biological sample; and (ii) dispensing the composition of any one of the first through fourth aspects of the present disclosure set forth above to the biological sample. In some embodiments, the silver ions are derived from silver nitrate or silver acetate. In some embodiments, the silver-staining composition is introduced to the biological sample and permitted to incubate with the sample for a first predetermined period of time at a first predetermined temperature. In some embodiments, the first predetermined period of time ranges from between about 1 minute to about 30 minutes. In some embodiments, the first predetermined temperature ranges from between about 25° C. to about 60° C. In some embodiments, the composition of any one of the first through fourth aspects is permitted to incubate with the biological sample for a second predetermined period of time at a second predetermined temperature. In some embodiments, the second predetermined period of time ranges from between about 4 minutes to about 30 minutes. In some embodiments, the second predetermined temperature ranges from between about 45° C. to about 65° C. In some embodiments, the method further comprises counterstaining the biological sample.

A sixth aspect of the present disclosure is a kit comprising: (i) a silver-staining composition; (ii) the composition of any one of the first through fourth aspects of the present disclosure set forth above; and (iii) a counterstaining composition.

A sixth aspect of the present disclosure is a kit comprising: (i) a silver-staining composition; and (ii) the composition of any one of the first through fourth aspects of the present disclosure set forth above.

An eighth aspect of the present disclosure is a system comprising (i) an automated staining apparatus; and (ii) at least one dispenser configured to dispense any one of the compositions of any one of the first through fourth aspects of the present disclosure set forth above.

A ninth aspect of the present disclosure is a stained biological sample, wherein the stained biological sample is prepared by (i) dispensing a silver-staining composition comprising silver ions to the biological sample; and (ii) dispensing the composition of any one of the first through fourth aspects of the present disclosure set forth above to the biological sample. In some embodiments, the silver ions are derived from silver nitrate or silver acetate. In some embodiments, the silver-staining composition is introduced to the biological sample and permitted to incubate with the sample for a first predetermined period of time at a first predetermined temperature. In some embodiments, the first predetermined period of time ranges from between about 1 minute to about 30 minutes. In some embodiments, the first predetermined temperature ranges from between about 25° C. to about 60° C. In some embodiments, the composition of any one of the first through fourth aspects is permitted to incubate with the biological sample for a second predetermined period of time at a second predetermined temperature. In some embodiments, the second predetermined period of time ranges from between about 4 minutes to about 30 minutes. In some embodiments, the second predetermined temperature ranges from between about 45° C. to about 65° C. In some embodiments, the method further comprises counterstaining the biological sample.

A tenth aspect of the present disclosure is a composition comprising: (a) a solvent; (b) a silver complexing agent; (c) a pH buffering compound, such as wherein the pH buffering compound is not borax; and (d) a pH adjuster. In some embodiments, the solvent comprises water and a lower alcohol. In some embodiments, the lower alcohol is a C₁-C₄ alcohol. In some embodiments, the C₁-C₄ alcohol is isopropyl alcohol.

### BRIEF DESCRIPTION OF THE FIGURES

For a general understanding of the features of the disclosure, reference is made to the drawings. In the drawings, like reference numerals have been used throughout to identify identical elements.

FIG. 1 illustrates a method of silver staining a biological sample in accordance with one embodiment of the present disclosure.

FIG. 2 illustrates a method of incubating a sample with a silver staining composition and separately a silver buffer composition in accordance with one embodiment of the present disclosure.

FIG. 3 illustrates a comparison between staining intensities achieved at different times and/or temperatures using an “on-market” Jones Staining component including borax and methenamine (top left, bottom left) and the silver buffer composition of the present disclosure (“New Formulation”) (top right, bottom right).

FIG. 4 provides images of stained tissue, prepared using the on-market Jones Silver B (available from Ventana Medical Systems, Inc.; Tucson AZ) and the silver buffer compositions of the present disclosure at unstressed (storage at about 2-about 8° C.) and stressed (storage at about 45° C. for about 7 consecutive days) conditions.

### DETAILED DESCRIPTION

It should also be understood that, unless clearly indicated to the contrary, in any methods claimed herein that include more than one step or act, the order of the steps or acts of the method is not necessarily limited to the order in which the steps or acts of the method are recited.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either” “one of,” “only one of” or “exactly one of.” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein, the term “about” refers to a range of values including the specified value, which a person of ordinary skill in the art would consider reasonably similar to the specified value. In some embodiments, the term “about” means within a standard deviation using measurements generally acceptable in the art. In some embodiments, about means a range extending to +/−10% of the specified value.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, a “biological sample” is any solid or fluid sample obtained from, excreted by or secreted by any living organism, including without limitation, single celled organisms, such as bacteria, yeast, protozoans, and amoebas among others, multicellular organisms (such as plants or animals, including samples from a healthy or apparently healthy human subject or a human patient affected by a condition or disease to be diagnosed or investigated, such as cancer). For example, a biological sample can be a biological fluid obtained from, for example, blood, plasma, serum, urine, bile, ascites, saliva, cerebrospinal fluid, aqueous or vitreous humor, or any bodily secretion, a transudate, an exudate (for example, fluid obtained from an abscess or any other site of infection or inflammation), or fluid obtained from a joint (for example, a normal joint or a joint affected by disease). A biological sample can also be a sample obtained from any organ or tissue (including a biopsy or autopsy specimen, such as a tumor biopsy) or can include a cell (whether a primary cell or cultured cell) or medium conditioned by any cell, tissue or organ. In some examples, a biological sample is a nuclear extract. In certain examples, a sample is a quality control sample, such as one of the disclosed cell pellet section samples. In other examples, a sample is a test sample. For example, a test sample is a cell, a tissue or cell pellet section prepared from a biological sample obtained from a subject. In an example, the subject is one that is at risk or has acquired. Samples can be prepared using any method known in the art by of one of ordinary skill. The samples can be obtained from a subject for routine screening or from a subject that is suspected of having a disorder, such as a genetic abnormality, infection, or a neoplasia. The described embodiments of the disclosed method can also be applied to samples that do not have genetic abnormalities, diseases, disorders, etc., referred to as “normal” samples. Samples can include multiple targets that can be specifically bound by one or more detection probes.

As used herein, the term “borax” refers to a compound comprised of boric acid and sodium borate. Because it contains a 1:1 mixture of a weak acid (boric acid) and a weak base (sodium borate), it forms a pH buffer when it is dissolved in water. It is believed that the pKa of boric acid is 9.2, so when borax is dissolved in water it forms a buffered solution with a pH of about 9.2.

As used herein, the term “lower alcohol” refers to a C₁-C₆ alcohol, which may be linear or branched. Examples of lower alcohols include methanol, ethanol, propanol, and butanol, as well as isomers thereof.

As used herein, “methenamine” refers to an amine compound whose conjugate acid has a relatively low pKa of 4.9. It is believed that when dissolved in water and held at pH levels above 9, methenamine is completely deprotonated and can effectively complex silver ion.

As used herein, the term “slide” refers to any substrate (e.g., substrates made, in whole or in part, glass, quartz, plastic, silicon, etc.) of any suitable dimensions on which a biological specimen is placed for analysis, and more particularly to a “microscope slide” such as a standard 3 inch by 1 inch microscope slide or a standard 75 mm by 25 mm microscope slide. Examples of biological specimens that can be placed on a slide include, without limitation, a cytological smear, a thin tissue section (such as from a biopsy), and an array of biological specimens, for example a tissue array, a cellular array, a DNA array, an RNA array, a protein array, or any combination thereof. Thus, in one embodiment, tissue sections, DNA samples, RNA samples, and/or proteins are placed on a slide at particular locations. In some embodiments, the term slide may refer to SELDI and MALDI chips, and silicon wafers.

As used herein, the term “specific binding entity” refers to a member of a specific-binding pair. Specific binding pairs are pairs of molecules that are characterized in that they bind each other to the substantial exclusion of binding to other molecules (for example, specific binding pairs can have a binding constant that is at least 103 M−1 greater, 104 M−1 greater or 105 M−1 greater than a binding constant for either of the two members of the binding pair with other molecules in a biological sample). Examples of specific binding moieties include specific binding proteins (for example, antibodies, lectins, avidins such as streptavidins, and protein A). Specific binding moieties can also include the molecules (or portions thereof) that are specifically bound by such specific binding proteins. Specific binding entities include primary antibodies, described above, or nucleic acid probes.

As used herein, the terms “stain,” “staining,” or the like as used herein generally refers to any treatment of a biological specimen that detects and/or differentiates the presence, location, and/or amount (such as concentration) of a particular molecule (such as a lipid, protein or nucleic acid) or particular structure (such as a normal or malignant cell, cytosol, nucleus, Golgi apparatus, or cytoskeleton) in the biological specimen. For example, staining can provide contrast between a particular molecule or a particular cellular structure and surrounding portions of a biological specimen, and the intensity of the staining can provide a measure of the amount of a particular molecule in the specimen. Staining can be used to aid in the viewing of molecules, cellular structures and organisms not only with bright-field microscopes, but also with other viewing tools, such as phase contrast microscopes, electron microscopes, and fluorescence microscopes. Some staining performed by the system 2 can be used to visualize an outline of a cell. Other staining performed by the system 2 may rely on certain cell components (such as molecules or structures) being stained without or with relatively little staining other cell components. Examples of types of staining methods performed by the system 2 include, without limitation, histochemical methods, immunohistochemical methods, and other methods based on reactions between molecules (including non-covalent binding interactions), such as hybridization reactions between nucleic acid molecules. Staining methods include, but are not limited to, primary staining methods (e.g., H&E staining, Pap staining, etc.), enzyme-linked immunohistochemical methods, and in situ RNA and DNA hybridization methods, such as fluorescence in situ hybridization (FISH).

The present disclosure is directed to silver buffer compositions for staining a biological sample, wherein the disclosed silver buffer compositions do not include borax. It is believed that the disclosed silver buffer compositions are REACH compliant; and are suitable for use with automated staining instruments (e.g., BENCHMARK, available from Ventana Medical Systems, Inc.). Additionally, it is believed that the disclosed silver buffer compositions can eliminate staining intensity variability as compared with silver staining formulations including methenamine.

### Overview

The present disclosure is also directed to kits including a silver buffer composition, where the kits do not include any component which includes borax and/or methenamine. Additionally, the present disclosure also provides methods of staining a biological sample, such as silver staining a biological sample, where the methods do not utilize borax and/or methenamine.

### Silver Buffer Compositions

The present disclosure is directed to silver buffer compositions comprising a solvent; a silver complexing agent; and a pH buffering compound. In some embodiments, the present disclosure is directed to silver buffer compositions comprising a solvent; a silver complexing agent; and a pH buffering compound other than borax. In other embodiments, the present disclosure is directed to silver buffer compositions comprising a solvent; a silver complexing agent other than methenamine; and a pH buffering compound other than borax. In other embodiments, the present disclosure is directed to a silver buffer composition consisting essentially of a solvent; a silver complexing agent other than methenamine; and a pH buffering compound other than borax. In yet other embodiments, the present disclosure is directed to a silver buffer composition consisting of a solvent; a silver complexing agent other than methenamine; and a pH buffering compound other than borax.

In some embodiments, the solvent is water. In other embodiments, the solvent is a mixture of water and an alcohol. In some embodiments, the alcohol is a lower alcohol. In some embodiments, the lower alcohol is isopropyl alcohol. In other embodiments, the lower alcohol is n-propanol. In yet other embodiments, the lower alcohol is methanol. In yet other embodiments, the lower alcohol is ethanol. In yet other embodiments, the lower alcohol is ethylene glycol. In yet other embodiments, the lower alcohol is propylene glycol.

In some embodiments, a ratio of water to lower alcohol within the solvent is about 1:about 1. In other embodiments, a ratio of water to lower alcohol within the solvent is about 1:about 2. In yet other embodiments, a ratio of water to lower alcohol within the solvent is about 1:about 3. In some embodiments, an amount of lower alcohol within the solvent ranges from between about 5% to about 50% by total volume of the solvent. In some embodiments, an amount of lower alcohol within the solvent ranges from between about 10% to about 50% by total volume of the solvent. In other embodiments, an amount of lower alcohol within the solvent ranges from between about 10% to about 40% by total volume of the solvent. In some embodiments, an amount of lower alcohol within the solvent is about 5% by total volume of the solvent. In some embodiments, an amount of lower alcohol within the solvent is about 10% by total volume of the solvent. In some embodiments, an amount of lower alcohol within the solvent is about 15% by total volume of the solvent. In some embodiments, an amount of lower alcohol within the solvent is about 20% by total volume of the solvent. In some embodiments, an amount of lower alcohol within the solvent is about 25% by total volume of the solvent. In some embodiments, an amount of lower alcohol within the solvent is about 30% by total volume of the solvent. In some embodiments, an amount of lower alcohol within the solvent is about 35% by total volume of the solvent. In some embodiments, an amount of lower alcohol within the solvent is about 40% by total volume of the solvent.

In some embodiments, the solvent is a mixture of water and a glycol ether. In some embodiments, the glycol ether is polypropylene glycol, propylene glycol propyl ether, dipropylene glycol propyl ether, dipropylene glycol methyl ether, and propylene glycol methyl ether. In some embodiment, a ratio of water to glycol ether within the solvent is about 1:about 1. In other embodiment, a ratio of water to glycol ether within the solvent is about 1:about 2. In yet other embodiment, a ratio of water to glycol ether within the solvent is about 1:about 3. In some embodiments, an amount of glycol ether within the solvent ranges from between about 5% to about 50% by total volume of the solvent. In some embodiments, an amount of glycol ether within the solvent ranges from between about 10% to about 50% by total volume of the solvent. In other embodiments, an amount of glycol ether within the solvent ranges from between about 10% to about 40% by total volume of the solvent. In some embodiments, an amount of glycol ether within the solvent is about 5% by total volume of the solvent. In some embodiments, an amount of glycol ether within the solvent is about 10% by total volume of the solvent. In some embodiments, an amount of glycol ether within the solvent is about 15% by total volume of the solvent. In some embodiments, an amount of glycol ether within the solvent is about 20% by total volume of the solvent. In some embodiments, an amount of glycol ether within the solvent is about 25% by total volume of the solvent. In some embodiments, an amount of glycol ether within the solvent is about 30% by total volume of the solvent. In some embodiments, an amount of glycol ether within the solvent is about 35% by total volume of the solvent. In some embodiments, an amount of glycol ether within the solvent is about 40% by total volume of the solvent.

In some embodiments, the pH buffering compound has a pKa greater than about 8.5, such as a pKa greater than about 8.6, such as a pKa greater than about 8.7, such as a pKa greater than about 8.8, such as a pKa greater than about 8.9, such as a pKa greater than about 9, such as a pKa greater than about 9.1, such as a pKa greater than about 9.2, such as a pKa greater than about 9.3, such as a pKa greater than about 9.4, such as a pKa greater than about 9.5, such as a pKa greater than about 9.6, such as a pKa greater than about 9.7, etc. In some embodiments, the pH buffering compound is not borax.

In some embodiments, the pH buffering compound is selected from 2,4-pentanedionate, a carbonate (H₂CO₃) salt (such as sodium carbonate), 1,4-diazabicyclo[2.2.2]octane (DABCO), a pyrophosphate (e.g., disodium pyrophosphate (Na₂H₂P₂O₇) and tetrasodium pyrophosphate (Na₄P₂O₇)), 3-(N-morpholino) propanesulfonic acid (MOPS), 3-(Cyclohexylamino)-2-hydroxy-1-propanesulfonic acid (CAPSO), N-(1,1-Dimethyl-2-hydroxyethyl)-3-amino-2-hydroxypropanesulfonic acid (AMPSO), trimethylamine, sodium 2,4-pentanedionate, or N-cyclohexyl-2-aminoethanesulfonic acid (CHES).

In some embodiments, the pH buffering compound is present in an amount ranging from between about 1% to about 15% by weight of the silver buffer composition. In some embodiments, the pH buffering compound is present in an amount ranging from between about 1% to about 10% by weight of the silver buffer composition. In some embodiments, the pH buffering compound is present in an amount ranging from between about 1% to about 5% by weight of the silver buffer composition. In some embodiments, the pH buffering compound is present in amount of about 1%, such as about 2%, such as about 3%, such as about 4%, such as about 5%, such as about 6%, such as about 7%, such as about 8%, such as about 9%, such as about 10%, etc. by weight of the silver buffer composition.

In some embodiments, the pH buffering compound is DABCO. In some embodiments, a concentration of DABCO utilized in any silver buffer composition ranges from between about 90 mM and about 175 mM. In other embodiments, a concentration of DABCO utilized in any silver buffer composition ranges from between about 120 mM and about 150 mM. In some embodiments, a concentration of DABCO utilized in any silver buffer composition is about 128 mM. In other embodiments, a concentration of DABCO utilized in any silver buffer composition is about 130 mM. In some embodiments, a concentration of DABCO utilized in any silver buffer composition is about 132 mM. In some embodiments, a concentration of DABCO utilized in any silver buffer composition is about 134 mM. In some embodiments, a concentration of DABCO utilized in any silver buffer composition is about 136 mM. In some embodiments, a concentration of DABCO utilized in any silver buffer composition is about 138 mM. In some embodiments, a concentration of DABCO utilized in any silver buffer composition is about 140 mM. In some embodiments, a concentration of DABCO utilized in any silver buffer composition is about 142 mM.

In some embodiments, the silver complexing agent has a pKa less than about 8.5, such a pKa less than about 8.4, such a pKa less than about 8.3, such a pKa less than about 8.2, such a pKa less than about 8.1, such a pKa less than about 8, etc.

In some embodiments, the silver complexing agent is of ethanolamine (2-aminoethanol), triethanolamine (N(CH₂CH₂OH)₃), 1,3-bis(tris(hydroxymethyl)methylamino) propane (referred to as “BIS-TRIS Propane” or “BTP”), or 4-(2-hydroxyethyl) morpholine (HEMO). In other embodiments, the silver complexing agent is selected from Tetra sodium pyrophosphate, Sodium carbonate, 2-(Cyclohexylamino) ethane-1-sulfonic acid (CHES), 1,4-diazabicyclo[2.2.2]octane (DABCO), Triethylamine (TEA), 3-(N-morpholino) propanesulfonic acid (MOPS), 1,3-Diaminopropane, 1,2-Diaminopropane, 1,6-Diaminohexane, Diethylenetriamine, 3-(Cyclohexylamino)-2-hydroxy-1-propanesulfonic acid (CAPSO), N-(1,1-Dimethyl-2-hydroxyethyl)-3-amino-2-hydroxypropanesulfonic acid (AMPSO), Trimethylamine, and Sodium 2,4-pentanedionate.

In some embodiments, the silver complexing agent is present in an amount ranging from between about 1% to about 25% by weight of the silver buffer composition. In some embodiments, the silver complexing agent is present in an amount ranging from between about 1% to about 20% by weight of the silver buffer composition. In some embodiments, the silver complexing agent is present in an amount ranging from between about 1% to about 15% by weight of the silver buffer composition.

In some embodiments, the silver complexing agent is triethanolamine. In some embodiments, a concentration of triethanolamine utilized in any silver buffer composition ranges from between about 200 mM and about 300 mM. In other embodiments, a concentration of triethanolamine utilized in any silver buffer composition ranges from between about 230 mM and about 270 mM. In yet other embodiments, a concentration of triethanolamine utilized in any silver buffer composition ranges from between about 240 mM and about 260 mM. In some embodiments, a concentration of triethanolamine utilized in any silver buffer composition is about 235 mM. In other embodiments, a concentration of triethanolamine utilized in any silver buffer composition is about 240 mM. In some embodiments, a concentration of triethanolamine utilized in any silver buffer composition is about 245 mM. In some embodiments, a concentration of triethanolamine utilized in any silver buffer composition is about 246 mM. In some embodiments, a concentration of triethanolamine utilized in any silver buffer composition is about 247 mM. In some embodiments, a concentration of triethanolamine utilized in any silver buffer composition is about 248 mM. In some embodiments, a concentration of triethanolamine utilized in any silver buffer composition is about 249 mM. In some embodiments, a concentration of triethanolamine utilized in any silver buffer composition is about 250 mM. In some embodiments, a concentration of triethanolamine utilized in any silver buffer composition is about 251 mM. In some embodiments, a concentration of triethanolamine utilized in any silver buffer composition is about 252 mM. In some embodiments, a concentration of triethanolamine utilized in any silver buffer composition is about 253 mM. In some embodiments, a concentration of triethanolamine utilized in any silver buffer composition is about 255 mM. In some embodiments, a concentration of triethanolamine utilized in any silver buffer composition is about 260 mM.

In some embodiments, the silver buffer compositions of the present disclosure have a pH ranging from between about 9.2 to about 10. In other embodiments, the silver buffer compositions of the present disclosure have a pH ranging from between about 9.3 to about 9.9. In other embodiments, the silver buffer compositions of the present disclosure have a pH ranging from between about 9.4 to about 9.8. In yet other embodiments, the silver buffer compositions of the present disclosure have a pH ranging from between about 9.5 to about 9.7. In some embodiments, the silver buffer compositions of the present disclosure have a pH of about 9.4. In other embodiments, the silver buffer compositions of the present disclosure have a pH of about 9.5. In yet other embodiments, the silver buffer compositions of the present disclosure have a pH of about 9.6. In further embodiments, the silver buffer compositions of the present disclosure have a pH of about 9.7. In even further embodiments, the silver buffer compositions of the present disclosure have a pH of about 9.8.

The skilled artisan will be able to adjust the pH of the silver buffer compositions by adding an appropriate amount of an appropriate acid. In this regard, and in some embodiments, the silver buffer compositions of the present disclosure further include an acid. In some embodiments, the acid is an inorganic acid or an organic acid; and may be selected from monoprotic acids or polyprotic acids. In some embodiments, the acid is a strong acid. In some embodiments, the strong acid is selected from hydrochloric acid, sulfuric acid, perchloric acid, nitric acid or mixtures thereof. In other embodiments, the strong acid is hydrochloric acid. In some embodiments, the strong acid is nitric acid. In other embodiments, the acid is a weak acid. Suitable weak acids include those having a pKa less than about 7. Examples of suitable weak acids include, but are not limited to, nitrous acid, formic acid, acetic acid, phosphoric acid, and benzoic acid.

The skilled artisan will be able to select any acid that allows for the silver buffer composition to achieve a predetermined pH or pH range, such as any of those pHs or pH ranges disclosed above. The skilled artisan will appreciate that the amount of acid in the silver buffer compositions of the present disclosure may vary depending, of course, on the acid selected, the molarity of the acid, the normality of the acid, and/or the presence of other components in the silver buffer composition. In some embodiments, the amount of acid in any silver buffer composition ranges from about 0.001% to about 6% by total volume of the silver buffer composition. In some embodiments, the amount of acid in any silver buffer composition ranges from about 0.001% to about 5% by total volume of the silver buffer composition. In some embodiments, the amount of acid in any silver buffer composition ranges from about 0.001% to about 4% by total volume of the silver buffer composition. In other embodiments, the amount of acid in any silver buffer composition ranges from about 0.001% to about 2.5% by total volume of the silver buffer composition. In yet other embodiments, the amount of acid in any silver buffer composition ranges from about 0.01% to about 1% by total volume of the silver buffer composition. In some embodiments, an amount of acid is added until the appropriate silver buffer pH is achieved.

In some embodiments, the silver buffer compositions of the present disclosure further include one or more reducing sugars. In some embodiments, the reducing sugar is selected from xylose, ribose, or maltose. In some embodiments, an amount of the one or more reducing sugars to include in any silver buffer composition ranges from between about 0.001% to about 3% by total weight of the silver buffer composition. In some embodiments, an amount of the one or more reducing sugars to include in any silver buffer composition ranges from between about 0.001% to about 2% by total weight of the silver buffer composition. In some embodiments, an amount of the one or more reducing sugars to include in any silver buffer composition ranges from between about 0.001% to about 1% by total weight of the silver buffer composition.

In some embodiments, the silver buffer compositions of the present disclosure further include an antimicrobial agent. In some embodiments, the antimicrobial agent may be present in an amount ranging from between about 15% to about 70% by total volume of the silver buffer composition. In some embodiments, the antimicrobial agent is an alcohol, such as a lower alcohol (including any of those described herein). In some embodiments, a lower alcohol (e.g., isopropyl alcohol) included within the solvent functions as an antimicrobial agent and, in those embodiments where the solvent is a mixture of water and a lower alcohol, no additional antimicrobial agent is needed (or lower amounts of such antimicrobial agents are needed).

In some embodiments, the present disclosure is directed to silver buffer compositions comprising a solvent, triethanolamine, and DABCO. In some embodiments, the concentration of triethanolamine ranges from between about 230 mM to about 270 mM, such as between about 240 mM to about 260 mM, such as between about 245 mM to about 255 mM. In some embodiments, the concentration of DABCO ranges from between about 120 mM to about 150 mM, such as between about 125 mM to about 145 mM, such as between about 130 mM to about 140 mM. In some embodiments, the solvent is water. In some embodiments, the solvent comprises a mixture of water and a lower alcohol. In some embodiments, the solvent comprises a mixture of water and isopropyl alcohol. In some embodiments, the silver buffer composition has a pH ranging from about 9.3 to about 9.9. In some embodiments, the silver buffer composition has a pH ranging from about 9.4 to about 9.8. In some embodiments, the silver buffer composition has a pH ranging from about 9.5 to about 9.7. In some embodiments, the silver buffer composition further comprises nitric acid. In some embodiments, the silver buffer composition further comprises a reducing sugar. In some embodiments, the silver buffer composition further comprises an antimicrobial agent.

Non-limiting examples of silver buffer compositions in accordance with the present disclosure are set forth in Tables 1 to 3:

TABLE 1
Examples of suitable staining silver buffer compositions.

| Component | Concentration | |
|---|---|---|
| DI Water | 85 | v/v % |
| Isopropyl alcohol | 15 | v/v % |
| Triethanolamine | 230 to 270 | mM |
| DABCO | 120-150 | mM |

pH of 9.3-9.9

TABLE 2
Examples of suitable staining silver buffer compositions.

| | Silver Buffer | | Silver Buffer | |
|---|---|---|---|---|
| | Composition | | Composition | |
| Component | Embodiment 1 | | Embodiment 2 | |
| DI Water | 85 | v/v % | 85 | v/v % |
| Isopropyl alcohol | 15 | v/v % | 15 | v/v % |
| Triethanolamine | 249 | mM | 250 | mM |
| DABCO | 134 | mM | 130 | mM |

| | | |
|---|---|---|
| pH of the silver buffer | 9.5-9.7 | 9.4 |
| composition | | |
| Reducing sugar | — | 0.005M |

TABLE 3
Examples of suitable staining silver buffer compositions.

| Silver Buffer | | | | |
|---|---|---|---|---|
| Composition | Isopropyl | | | |
| Embodiment | Alcohol | Triethanolamine | DABCO | 1M Nitric Acid |
| 3 | 180.0 mL | 37.2 g | 15.0 g | 18.0 mL |
| 4 | 120.0 mL | 37.2 g | 15.0 g | 18.0 mL |
| 5 | 150.0 mL | 39.1 g | 15.0 g | 18.0 mL |
| 6 | 150.0 mL | 35.3 g | 15.0 g | 18.0 mL |
| 7 | 150.0 mL | 37.2 g | 15.8 g | 18.0 mL |
| 8 | 150.0 mL | 37.2 g | 14.3 g | 18.0 mL |
| 9 | 150.0 mL | 37.2 g | 15.0 g | 21.6 mL |
| 10 | 150.0 mL | 37.2 g | 15.0 g | 14.4 mL |
| 11 | 150.0 mL | 37.2 g | 15.0 g | 18.0 mL |
| 12 | 150.0 mL | 37.2 g | 15.0 g | 18.0 mL |
| 13 | 150.0 mL | 37.2 g | 15.0 g | 18.0 mL |

In some embodiments, the present disclosure is directed to a silver buffer composition consisting essentially of a solvent, triethanolamine at a concentration ranging from between about 230 mM to about 270, and DABCO at a concentration from between about 120 mM to about 150 mM; wherein the silver buffer composition has a pH ranging from about 9.3 to about 9.9. In some embodiments, the present disclosure is directed to a silver buffer composition consisting of a solvent, triethanolamine at a concentration ranging from between about 230 mM to about 270, and DABCO at a concentration from between about 120 mM to about 150 mM; wherein the silver buffer composition has a pH ranging from about 9.3 to about 9.9.

### Kits

The present disclosure also provides for kits, such as kits for staining and/or counterstaining a biological sample. The kits of the present disclosure do not include borax, and is therefore REACH-compliant, while also eliminating methenamine and any variability associated with it. The kits of the present disclosure are also able to provide consistent staining to biological samples, even after long-term storage (e.g., about 5 days, about 7 days, about 10 days, about 15 days, about 30 days, about 45 days, about 60 days, etc.) (see, e.g., FIG. 4).

In some embodiments, the kits of the present disclosure include a first component including one of the silver buffer compositions described herein; and at least a second component. In some embodiments, the second component comprises periodic acid or a silver salt (e.g., silver nitrate). In some embodiments, the kits of the present disclosure include a first component including one of the silver buffer compositions described herein; a second component including periodic acid; and a third component including a silver salt (e.g., silver nitrate). In some embodiments, the kits include at least one further component selected from a toner (e.g., gold chloride) and a fixer (e.g., sodium thiosulfate). In some embodiments, the kits further include an optional additional staining component, e.g., hematoxylin (such as Mayer's hematoxylin, which includes sodium iodate and ethylene glycol), eosin (such as eosin included in an alcohol solution), and a light green stain (e.g., Light Green Y, available from Ventana Medical Systems, Inc.; Tucson, AZ).

In some embodiments, the present disclosure provides a kit comprising:
(a) a first container including a silver buffer composition comprising, consisting essentially of, or consisting of a solvent; a silver complexing agent other than methenamine; and a pH buffering compound other than borax;
(b) a second container including periodic acid, such as 1% periodic acid (e.g., Jones Periodic Acid, available from Ventana Medical Systems, Inc.; Tucson, AZ);
(c) a third container including silver nitrate, such as 1% silver nitrate (e.g., Jones Silver A, available from Ventana Medical Systems, Inc; Tucson, AZ);
(d) optionally a fourth container including a Toner, such as gold chloride;
(e) optionally a fifth container including a fixer, such as sodium thiosulfate; (e)
(f) optionally a sixth container including hematoxylin, such as Mayer's Hematoxylin (e.g., Jones Hematoxylin, available from Ventana Medical Systems, Inc.; Tucson, AZ);
(g) optionally a seventh container including eosin (e.g., Jones Eosin, available from Ventana Medical Systems, Inc.; Tucson, AZ); and
(h) optionally an eighth container including a green counterstain (e.g., Jones Light Green, available from Ventana Medical Systems, Inc.; Tucson, AZ).

In other embodiments, the present disclosure provides a kit comprising:
(a) a first container including a silver buffer composition comprising, consisting essentially of, or consisting of a solvent, triethanolamine at a concentration ranging from between about 230 mM to about 270, and DABCO at a concentration from between about 120 mM to about 150 mM; wherein the silver buffer composition has a pH ranging from about 9.3 to about 9.9;
(b) a second container including periodic acid, such as 1% periodic acid (e.g., Jones Periodic Acid, available from Ventana Medical Systems, Inc.; Tucson, AZ);
(c) a third container including silver nitrate, such as 1% silver nitrate (e.g., Jones Silver A, available from Ventana Medical Systems, Inc; Tucson, AZ);
(d) optionally a fourth container including a Toner, such as gold chloride;
(e) optionally a fifth container including a fixer, such as sodium thiosulfate;
(f) optionally a sixth container including hematoxylin, such as Mayer's Hematoxylin (e.g., Jones Hematoxylin, available from Ventana Medical Systems, Inc.; Tucson, AZ);
(g) optionally a seventh container including eosin (e.g., Jones Eosin, available from Ventana Medical Systems, Inc.; Tucson, AZ); and
(h) optionally an eighth container including a green counterstain (e.g., Jones Light Green, available from Ventana Medical Systems, Inc.; Tucson, AZ).

In yet other embodiments, the present disclosure provides a kit comprising:
(a) a first container including a silver buffer composition as set forth in any one of Tables 1-3;
(b) a second container including periodic acid, such as 1% periodic acid (e.g., Jones Periodic Acid, available from Ventana Medical Systems, Inc.; Tucson, AZ);
(c) a third container including silver nitrate, such as 1% silver nitrate (e.g., Jones Silver A, available from Ventana Medical Systems, Inc; Tucson, AZ);
(d) optionally a fourth container including a Toner, such as gold chloride;
(e) optionally a fifth container including a fixer, such as sodium thiosulfate;
(f) optionally a sixth container including hematoxylin, such as Mayer's Hematoxylin (e.g., Jones Hematoxylin, available from Ventana Medical Systems, Inc.; Tucson, AZ);
(g) optionally a seventh container including eosin (e.g., Jones Eosin, available from Ventana Medical Systems, Inc.; Tucson, AZ); and
(h) optionally an eighth container including a green counterstain (e.g., Jones Light Green, available from Ventana Medical Systems, Inc.; Tucson, AZ).

In some embodiments, the kits of the president disclosure include one or more specific binding entities, such as oligonucleotide probes and/or monoclonal antibodies. In some embodiments, the kits further include one or more detection reagents for detecting the one or more specific binding entities.

### Methods

The present disclosure also provides for methods of staining a biological sample, such as a biological sample disposed on a substrate (e.g., a microscope slide), where the staining includes a step where any one of the silver buffer compositions described herein are introduced to the biological sample. In some embodiments, the biological sample is a cytological sample. In other embodiments, the biological sample is a histological sample. In some embodiments, the biological sample is derived from a tumor sample; or a sample that is suspected of including a tumor.

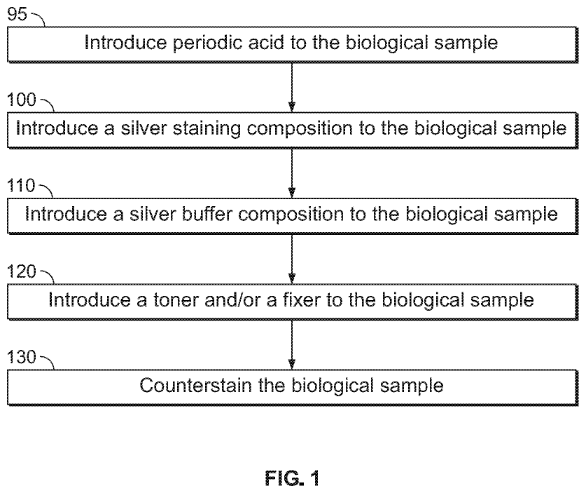

In some embodiments, and with reference to FIG. 1, the method comprises (i) introducing a silver staining composition comprising any source of a silver ion, such as a silver salt to the biological sample (step 100); and (ii) introducing any one of the silver buffer compositions described herein (e.g., any one of the compositions set forth in Tables 1-3) to the biological sample (step 110). In some embodiments, the silver-staining composition comprises silver nitrate or silver acetate. In some embodiments, the method further comprises introducing periodic acid to the biological sample prior to or contemporaneously with the introduction of the silver-staining composition (step 95).

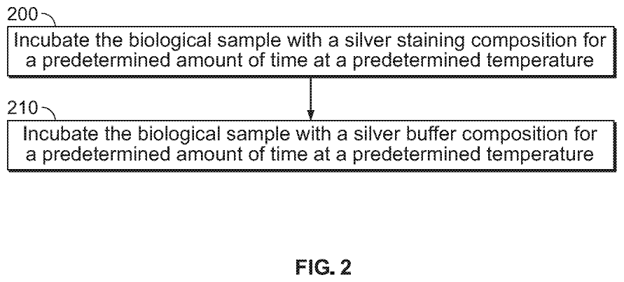

In some embodiments, the silver-staining composition is introduced prior to introducing the silver buffer composition. In some embodiments, the silver-staining composition is introduced to the biological sample and permitted to incubate with the sample for a predetermined time period at a predetermined temperature (see FIG. 2, step 200). For instance, the silver-staining composition is permitted to incubate with the biological sample for a period of time ranging from between about 1 minute to about 30 minutes, such as between about 2 minutes to about 30 minutes, such as between about 4 minutes to about 24 minutes, such as between about 4 minutes to about 20 minutes, such as between about 4 minutes and about 16 minutes, such as between about 4 minutes and 12 minutes, etc.

In some embodiments, the silver-staining composition is incubated with the biological sample at room temperature. In other embodiments, the silver-staining composition is incubated with the biological sample at a temperature greater than room temperature, such as at a temperature from between about 25° C. to about 60° C., such as between about 25° C. and about 55° C., such as between about 25° C. and about 50° C., such as between about 25° C. and about 45° C., such as between about 25° C. and about 40° C., such as between about 25° C. and about 35° C., etc.

In some embodiments, the silver buffer composition is subsequently introduced to the biological sample and permitted to incubate with the biological sample for a predetermined time period at a predetermined temperature (see FIG. 2, step 210). For instance, in some embodiments the silver buffer composition is incubated with the biological sample for a time period ranging from between about 4 minutes to about 30 minutes, such as between about 4 minutes to about 24 minutes, such as between about 4 minutes to about 20 minutes, such as between about 4 minutes and about 16 minutes, such as between about 4 minutes and 12 minutes, etc.

In some embodiments, the silver buffer composition is incubated at a temperature ranging from between about 45° C. to about 65° C., such as between about 50° C. to about 65° C., such as between about 55° C. to about 65° C., etc. In some embodiments, the silver buffer composition is incubated at a temperature of about 55° C. In some embodiments, the silver buffer composition is incubated at a temperature of about 56° C. In some embodiments, the silver buffer composition is incubated at a temperature of about 57° C. In some embodiments, the silver buffer composition is incubated at a temperature of about 58° C. In some embodiments, the silver buffer composition is incubated at a temperature of about 59° C. In some embodiments, the silver buffer composition is incubated at a temperature of about 60° C. In some embodiments, the silver buffer composition is incubated at a temperature of about 61° C. In some embodiments, the silver buffer composition is incubated at a temperature of about 62° C.

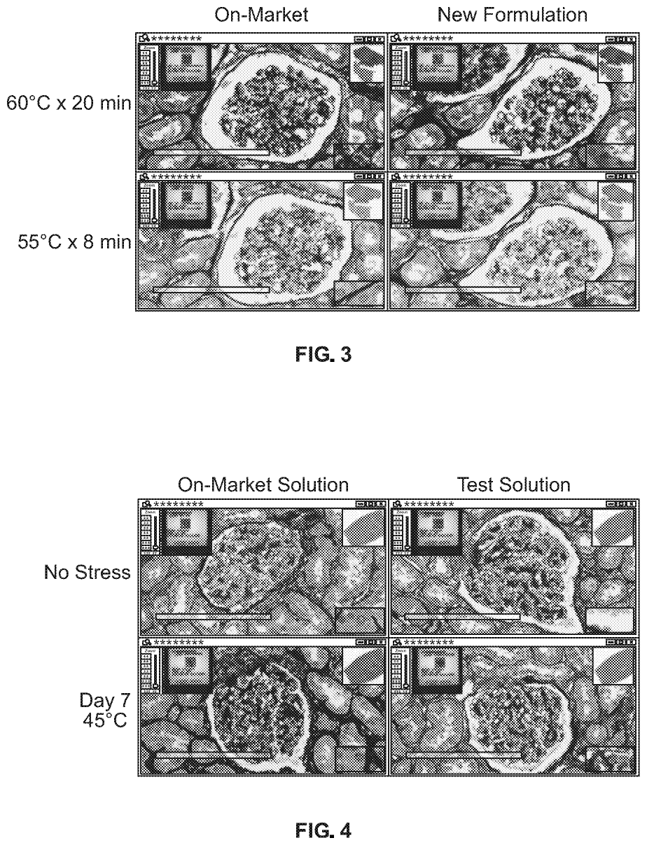

In some embodiments, the intensity of the staining effect (i.e., silver staining) may be “dialed in” by selecting a silver buffer composition having different reagent concentrations and/or a different overall pH; or by varying the incubation time and/or temperature of the silver buffer composition with the biological sample. For instance, incubating the sample with the silver buffer composition at a temperature of about 55° C. will provide a comparatively lighter staining intensity as compared with incubating the sample with the silver buffer composition at a temperature of about 60° C. (assuming the incubation time is the same). By way of another example, incubating the sample with the silver buffer composition for a duration of about 8 minutes will provide a comparatively lighter staining intensity as compared with incubating the sample with the silver buffer composition for a duration of about 20 minutes (assuming the incubation temperature is the same). As show in FIG. 3, use of the disclosed silver buffer compositions permits stain intensity to be “dialed in” to a similar or the same degree as using a conventional Jones staining component including borax and methenamine.

Non-limiting examples of silver buffer compositions including incubation times/temperatures are set forth in Table 4:

| | Active Ingredient Concentration in Silver Buffer | | | | Silver Buffer | |
|---|---|---|---|---|---|---|
| | Composition (per L of DI H₂O) | | | | Incubation | |
| Method | Isopropyl | | | 1M Nitric | Parameters | |
| Embodiment | Alcohol | Triethanolamine | DABCO | Acid | Temp. | Time |
| Control | 150.0 mL | 37.2 g | 15.0 g | 18.0 mL | 58° C. | 12 min |
| 1 | 180.0 mL | 37.2 g | 15.0 g | 18.0 mL | 58° C. | 12 min |
| 2 | 120.0 mL | 37.2 g | 15.0 g | 18.0 mL | 58° C. | 12 min |
| 3 | 150.0 mL | 39.1 g | 15.0 g | 18.0 mL | 58° C. | 12 min |
| 4 | 150.0 mL | 35.3 g | 15.0 g | 18.0 mL | 58° C. | 12 min |
| 5 | 150.0 mL | 37.2 g | 15.8 g | 18.0 mL | 58° C. | 12 min |
| 6 | 150.0 mL | 37.2 g | 14.3 g | 18.0 mL | 58° C. | 12 min |
| 7 | 150.0 mL | 37.2 g | 15.0 g | 21.6 mL | 58° C. | 12 min |
| 8 | 150.0 mL | 37.2 g | 15.0 g | 14.4 mL | 58° C. | 12 min |
| 9 | 150.0 mL | 37.2 g | 15.0 g | 18.0 mL | 60° C. | 12 min |
| 10 | 150.0 mL | 37.2 g | 15.0 g | 18.0 mL | 55° C. | 12 min |
| 11 | 150.0 mL | 37.2 g | 15.0 g | 18.0 mL | 58° C. | 20 min |
| 12 | 150.0 mL | 37.2 g | 15.0 g | 18.0 mL | 58° C. | 8 min |
| 13 | 150.0 mL | 37.2 g | 15.0 g | 18.0 mL | 60° C. | 20 min |
| 14 | 150.0 mL | 37.2 g | 15.0 g | 18.0 mL | 55° C. | 12 min |

After the introduction of the silver buffer composition, in some embodiments, the method further comprises optionally introducing a toner and/or a fixer to the biological sample (see FIG. 1, step 120). In some embodiments, both a toner and a fixer are sequentially or simultaneously introduced to the biological sample. In some embodiments, the toner includes gold chloride. In some embodiments, the fixer includes sodium thiosulfate.

In some embodiments, the method further comprises introducing one or more additional stains to the sample (see FIG. 1, step 130). For instance, a hematoxylin and/or eosin stain may be introduced to the biological sample. In some embodiments, the hematoxylin stain is Mayer's Hematoxylin. In some embodiments, the biological sample may be stained with hematoxylin and eosin. In other embodiments, the biological sample may be stained with hematoxylin and a green or light green stain.

In some embodiments, the biological sample is optionally further contacted with one or more specific binding entities, such as an antibody, an antibody fragment, or an oligonucleotide probe, specific for one or more targets within the biological sample. In some embodiments, the biological sample is yet further contacted with one or more detection agents to label the one or more specific binding entities with one or more detectable moieties.

After the specimens are processed, a user can transport specimen-bearing slides to an imaging apparatus for analysis or other downstream processing. For example, the imaging apparatus may be a brightfield imager slide scanner. One brightfield imager is the iScan Coreo™ brightfield scanner sold by Ventana Medical Systems, Inc. In automated embodiments, the imaging apparatus is a digital pathology device as disclosed in International Patent Application No.: PCT/US2010/002772 (Patent Publication No.: WO/2011/049608) entitled IMAGING SYSTEM AND TECHNIQUES or disclosed in U.S. Patent Application No. 61/533,114, filed on Sep. 9, 2011, entitled IMAGING SYSTEMS, CASSETTES, AND METHODS OF USING THE SAME. International Patent Application No. PCT/US2010/002772 and U.S. Patent Application Publication No. 2014/0178169 are incorporated by reference in their entities. In other embodiments, the imaging apparatus includes a digital camera coupled to a microscope.

### Systems

The present disclosure is also directed to a system comprising a specimen processing apparatus, where the specimen processing apparatus includes a container, dispenser, reservoir, or fluid conduit including any one of the silver buffer compositions of the present disclosure, such as any one of the silver buffer compositions set forth in any one of Tables 1-3.

In some embodiments, the specimen processing apparatus is an automated apparatus, such as the BENCHMARK XT instrument, the SYMPHONY instrument, the BENCHMARK ULTRA instrument sold by Ventana Medical Systems, Inc. Ventana Medical Systems, Inc. is the assignee of a number of United States patents disclosing systems and methods for performing automated analyses, including U.S. Pat. Nos. 5,650,327, 5,654,200, 6,296,809, 6,352,861, 6,827,901 and 6,943,029, and U.S. Published patents application Nos. 20030211630 and 20040052685, each of which is incorporated herein by reference in its entirety. Alternatively, specimens can be manually processed.

In some embodiments, the specimen processing apparatus can apply fixatives to the specimen. Fixatives can include cross-linking agents (such as aldehydes, e.g., formaldehyde, paraformaldehyde, and glutaraldehyde, as well as non-aldehyde cross-linking agents), oxidizing agents (e.g., metallic ions and complexes, such as osmium tetroxide and chromic acid), protein-denaturing agents (e.g., acetic acid, methanol, and ethanol), fixatives of unknown mechanism (e.g., mercuric chloride, acetone, and picric acid), combination reagents (e.g., Carnoy's fixative, methacarn, Bouin's fluid, B5 fixative, Rossman's fluid, and Gendre's fluid), microwaves, and miscellaneous fixatives (e.g., excluded volume fixation and vapor fixation).

In some embodiments, if the specimen is a sample embedded in paraffin, the sample can be deparaffinized with the specimen processing apparatus using appropriate deparaffinizing fluid(s). After the waste remover removes the deparaffinizing fluid(s), any number of substances can be successively applied to the specimen. The substances can be for pretreatment (e.g., protein-crosslinking, expose nucleic acids, etc.), denaturation, hybridization, washing (e.g., stringency wash), detection (e.g., link a visual or marker molecule to a probe), amplifying (e.g., amplifying proteins, genes, etc.), counterstaining, coverslipping, or the like.

In some embodiments, the specimen processing apparatus can apply a wide range of substances to the specimen, which may then be uniformly distributed and/or mixed using the acoustic source in communication with the slide holder. In some embodiments, the substances include, without limitation, stains, probes, reagents, rinses, and/or conditioners. In some embodiments, the substances can be fluids (e.g., gases, liquids, or gas/liquid mixtures), or the like. In some embodiments, the fluids can be solvents (e.g., polar solvents, non-polar solvents, etc.), solutions (e.g., aqueous solutions or other types of solutions), or the like. Reagents can include, without limitation, stains, wetting agents, antibodies (e.g., monoclonal antibodies, polyclonal antibodies, etc.), antigen recovering fluids (e.g., aqueous- or non-aqueous-based antigen retrieval solutions, antigen recovering buffers, etc.), or the like. Probes can be an isolated nucleic acid or an isolated synthetic oligonucleotide, attached to a detectable label. Labels can include radioactive isotopes, enzyme substrates, co-factors, ligands, chemiluminescent or fluorescent agents, haptens, and enzymes.

In some embodiments, the specimen processing apparatus includes one of more of: reservoirs of the various reagents used in the staining protocols, a reagent dispense unit in fluid communication with the reservoirs for dispensing reagent to onto a slide, a waste removal system for removing used reagents and other waste from the slide, and a control system that coordinates the actions of the reagent dispense unit and waste removal system. In addition to performing staining steps, many automated slide stainers can also perform steps ancillary to staining (or are compatible with separate systems that perform such ancillary steps), including slide baking (for adhering the sample to the slide), dewaxing (also referred to as deparaffinization), antigen retrieval, counterstaining, dehydration and clearing, and coverslipping. Prichard, Overview of Automated Immunohistochemistry, Arch Pathol Lab Med., Vol. 138, pp. 1578-1582 (2014), incorporated herein by reference in its entirety, describes several specific examples of automated IHC/ISH slide stainers and their various features, including the intelliPATH (Biocare Medical), WAVE (Celerus Diagnostics), DAKO OMNIS and DAKO AUTOSTAINER LINK 48 (Agilent Technologies), BENCHMARK (Ventana Medical Systems, Inc.), Leica BOND, and Lab Vision Autostainer (Thermo Scientific) automated slide stainers. Additionally, Ventana Medical Systems, Inc. is the assignee of a number of United States patents disclosing systems and methods for performing automated analyses, including U.S. Pat. Nos. 5,650,327, 5,654,200, 6,296,809, 6,352,861, 6,827,901 and 6,943,029, and U.S. Published patents application Nos. 20030211630 and 20040052685, each of which is incorporated herein by reference in its entirety.

### EXAMPLES

### Example 1-Ship Stress Performance

Solutions of on-market Jones Silver B (available from Ventana Medical Systems, Inc.; Tucson AZ) and the silver buffer compositions of the present disclosure were exposed to continuous −20° C., +35° C., and +45° C. temperatures for 7 days then used with the same kits to stain tissues for comparison. While the on-market solution fails within 7 days at +45° C. due to dark staining (methenamine degradation), the silver buffer compositions of the present disclosure performed consistently over the course of the study and never reached a point of failure with any of the temperature conditions tested (−20° C., +35° C., and 45° C.). FIG. 4 provides representative images for comparison.

Although the present disclosure has been described with reference to several illustrative embodiments, it should be understood that numerous other modifications and embodiments can be devised by those skilled in the art that will fall within the spirit and scope of the principles of this disclosure. More particularly, reasonable variations and modifications are possible in the component parts and/or arrangements of the subject combination arrangement within the scope of the foregoing disclosure, the drawings, and the appended claims without departing from the spirit of the disclosure. In addition to variations and modifications in the component parts and/or arrangements, alternative uses will also be apparent to those skilled in the art.

1. A buffer composition comprising water, isopropyl alcohol, triethanolamine, and DABCO, wherein the composition has a pH ranging from about 9.3 to about 9.9.

2. The buffer composition of claim 1, wherein the isopropyl alcohol is present in an amount of about 15% v/v %.

3. The buffer composition of claim 1, wherein the triethanolamine is present in an amount ranging from between about 230 mM to about 270 mM.

4. The buffer composition of claim 1, wherein the DABCO is present in an amount ranging from between about 120 mM to about 150 mM.

5. The buffer composition of claim 1, further comprising a reducing sugar.

6. The buffer composition of claim 1, wherein the buffer composition consists essentially of water, isopropyl alcohol, triethanolamine, and DABCO, wherein the composition has a pH ranging from about 9.3 to about 9.9.

7. The buffer composition of claim 1, wherein the buffer composition consists of water, isopropyl alcohol, triethanolamine, and DABCO, wherein the composition has a pH ranging from about 9.3 to about 9.9.

8. A method of staining a biological sample, comprising: (i) dispensing a silver-staining composition comprising silver ions to the biological sample; and (ii) dispensing the buffer composition of claim 1 to the biological sample.

9. The method of claim 8, wherein the silver ions are derived from silver nitrate or silver acetate.

10. The method of claim 8, wherein the silver-staining composition is introduced to the biological sample and permitted to incubate with the sample for a first predetermined period of time at a first predetermined temperature.

11. The method of claim 10, wherein the first predetermined period of time ranges from between about 1 minute to about 30 minutes.

12. The method of claim 10, wherein the first predetermined temperature ranges from between about 25° C. to about 60° C.

13. The method of claim 8, wherein the buffer composition is permitted to incubate with the biological sample for a second predetermined period of time at a second predetermined temperature.

14. The method of claim 13, wherein the second predetermined period of time ranges from between about 4 minute to about 30 minutes.

15. The method of claim 13, wherein the second predetermined temperature ranges from between about 45° C. to about 65° C.

16. The method of claim 8, further comprising counterstaining the biological sample.

17. A kit comprising: (i) a silver-staining composition; (ii) the buffer composition of claim 1 and (iii) a counterstaining composition.

18. A kit comprising: (i) a silver-staining composition; and (ii) the buffer composition of claim 1.

19. A system comprising (i) an automated staining apparatus; and (ii) at least one dispenser configured to dispense the buffer compositions of claim 1.

20. A stained biological sample, wherein the stained biological sample is prepared by (i) dispensing a silver-staining composition comprising silver ions to the biological sample; and (ii) dispensing the buffer composition of claim 1 to the biological sample.
